(19) United States
(12) Patent Application Publication
(10) Pub. No.: US 2026/0199842 A1
(43) Pub. Date: Jul. 16, 2026

(54) METHOD OF PRODUCING MOF MEMBRANE COMPLEX AND MOF MEMBRANE COMPLEX

(71) Applicant: NGK INSULATORS, LTD., Nagoya-City (JP)

(72) Inventors: Tomoyo AKAHIRA, Nagoya-Shi (JP); Daiki KAZAOKA, Tokai-Shi (JP); Makoto MIYAHARA, Tajimi-Shi (JP); Kenichi NODA, Nagoya-Shi (JP)

(73) Assignee: NGK INSULATORS, LTD., Nagoya-City (JP)

(21) Appl. No.: 19/462,016

(22) Filed: Jan. 28, 2026

Related U.S. Application Data
(63) Continuation of application No. PCT/JP2024/016885, filed on May 2, 2024.

(30) Foreign Application Priority Data
Sep. 6, 2023 (JP) 2023-144625

(51) Int. Cl. B01D 67/00; B01D 71/02

(52) U.S. Cl. CPC B01D 67/0079; B01D 71/028

(57) ABSTRACT

In the production of an MOF membrane complex, seed crystals of a CAU-10 MOF are deposited on a support, an Al source solution that is an aqueous solution containing an Al ion source is prepared, and a ligand solution is prepared in which an organic ligand used for synthesis of the CAU-10 MOS dissolves in a solvent. Then, a starting material solution is prepared by mixing the Al source solution and the ligand solution at a rate that does not cause the starting material solution to become cloudy. The support is immersed in the starting material solution to form an MOF membrane that is the CAU-10 MOF on the support by Solvothermal synthesis.

### CROSS-REFERENCE TO RELATED APPLICATIONS

The present application is a continuation application of International Application No. PCT/JP2024/016885 filed on May 2, 2024, which claims priority to Japanese Patent Application No. 2023-144625 filed on Sep. 6, 2023. The contents of these applications are incorporated herein by reference in their entirety.

### TECHNICAL FIELD

The present invention relates to a method of producing an MOF membrane complex and to an MOF membrane complex.

### BACKGROUND ART

In recent years, active researches have been conducted on metal-organic frameworks (hereinafter, also referred to as “MOFs”), which are crystalline porous materials constructed by coordinate bonds between metal ions and organic ligands. The MOFs are porous materials having large surface areas and, like zeolite membranes, are expected to be applied to the separation of gases or liquids by deposition on porous supports.

One type of the MOFs known is called “CAU-10”. CAU-10 MOFs are represented by Al(OH)(C₈H₃O₄X) and contain aluminum ions as metal ions and organic ligands in which functional groups X (including the case where X is a hydrogen atom) are bonded to carbon atoms at position number 5 in aromatic rings of isophthalic acid. Here, Al(OH)(C₈H₃O₄X) is expressed as “CAU-10-X”, and “Highly CO₂ Selective Metal-Organic Framework Membranes with Favorable Coulombic Effect”, by Da-Shiuan Chiou and other seven members, Advanced Functional Materials. 2021, 31, 2006924, Wiley-VCH GmbH (Document 1) reports a membrane of CAU-10-H formed on a flat plate. “Structures, Sorption Characteristics, and Non Linear Optical Properties of a New Series of Highly Stable Aluminum MOFs”, by Helge Reinsch and other six members, Chemistry of Materials, 2013, 25, 17-26, American Chemical Society (Document 2) relates to powder of CAU-10—NH₂, but mentions only cases where X is H, CH₃, OCH₃, NO₂, NH₂, or OH.

Incidentally, only CAU-10-H according to Document 1 is known as a membrane of the MOF expressed by CAU-10-X (hereinafter, referred to as “CAU-10 MOF”). The other CAU-10 MOFs are known only as powder.

If various types of starting materials are mixed in compounding ratios described in known documents such as Documents 1 and 2, the solutions obtained become cloudy. In this state, the concentrations of various starting materials vary within a solution, thereby making the starting materials unsuitable for formation of a membrane of a CAU-10 MOF. Even if a membrane of a CAU-10 MOF can be formed, areas where the membrane is not formed will be produced, or the membrane may have an uneven thickness. In particular, if a support with a certain degree of size is immersed in a deep container to form a membrane of an MOF, it is not possible to form the membrane with a uniform thickness.

### SUMMARY OF THE INVENTION

It is an object of the present invention to provide a method of producing an MOF membrane complex that includes a membrane of a CAU-10 MOF with little variation in thickness. It is also an object of the present invention to provide an MOF membrane complex that includes a membrane of a variety of CAU-10 MOFs.

Aspect 1 of the present invention is the method of producing an MOF membrane complex that includes a) depositing a seed crystal of a CAU-10 MOF on a support, b) preparing an Al source solution that is an aqueous solution containing an Al ion source, c) preparing a ligand solution in which an organic ligand used for synthesis of the CAU-10 MOF dissolves in a solvent, d) preparing a starting material solution by mixing the Al source solution and the ligand solution at a rate that does not cause the starting material solution to become cloudy, and e) immersing the support in the starting material solution to form an MOF membrane that is the CAU-10 MOF on the support by Solvothermal synthesis.

According to Aspect 1 of the present invention, it is possible to obtain the MOF membrane complex that includes a membrane of the CAU-10 MOF with little variation in thickness. It is also possible to obtain the MOF membrane complex that includes a membrane of the variety of CAU-10 MOFs.

Aspect 2 of the present invention is the method of producing an MOF membrane complex according to Aspect 1, in which in the operation d), the ligand solution is added dropwise to the Al source solution while stirring.

Aspect 3 of the present invention is the method of producing an MOF membrane complex according to Aspect 1 (or according to Aspect 1 or 2), in which in the operation d), the starting material solution being produced has a pH that is maintained to be higher than or equal to 2.5 and lower than or equal to 3.5.

Aspect 4 of the present invention is the method of producing an MOF membrane complex according to Aspect 1 (or according to any one of Aspects 1 to 3), in which a molar ratio of the solvent to the organic ligand in the ligand solution is higher than or equal to 40 and lower than or equal to 500.

Aspect 5 of the present invention is the method of producing an MOF membrane complex according to Aspect 1 (or according to any one of Aspects 1 to 4), in which the organic ligand is any one selected from isophthalic acid, 5-amino isophthalic acid, 5-methyl isophthalic acid, 5-methoxy isophthalic acid, 5-nitro isophthalic acid, and 5-hydroxy isophthalic acid.

Aspect 6 of the present invention is the method of producing an MOF membrane complex according to any one of Aspects 1 to 5, in which the support has a through hole, and in the operation e), the support is immersed in the starting material solution in a state in which a direction of extension of the through hole is parallel to a vertical direction.

Aspect 7 of the present invention is an MOF membrane complex that includes a support having a through hole, and an MOF membrane that is a CAU-10 MOF formed on an inner surface of the through hole or an outer surface of the support. When the support is divided into three equal parts in a longitudinal direction along which the through hole extends, and a membrane thickness of the MOF membrane at a center of each of the three equal parts in the longitudinal direction is acquired to obtain three membrane thicknesses, a maximum value of differences between an in-hole average membrane thickness value, which is an average value of the three membrane thicknesses, and the three membrane thicknesses is less than or equal to 30% of the in-hole average membrane thickness value.

Aspect 8 of the present invention is the MOF membrane complex according to Aspect 7, in which the support has two through holes that include the through hole and that are parallel to each other, and a maximum value of differences between an inter-hole average membrane thickness value, which is an average value of in-hole average membrane thickness values of the two through holes, and the in-hole average membrane thickness values of the two through holes is less than or equal to 30% of the inter-hole average membrane thickness value.

Aspect 9 of the present invention is the MOF membrane complex according to Aspect 7 (or according to Aspect 7 or 8), in which the through hole has a length of greater than or equal to 10 cm and less than or equal to 200 cm.

Aspect 10 of the present invention is the MOF membrane complex according to Aspect 7 (or according to any one of Aspects 7 to 9), in which the through hole has a maximum width of greater than or equal to 1 mm and less than or equal to 20 mm in a cross section perpendicular to the longitudinal direction, and the through hole has a length that is 10 times or more and 100 times or less of the maximum width of the through hole.

Aspect 11 of the present invention is an MOF membrane complex that includes a support and an MOF membrane that is a CAU-10 MOF formed on the support. An organic ligand used to form the MOF membrane is any one selected from 5-methyl isophthalic acid, 5-amino isophthalic acid, and 5-nitro isophthalic acid.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a sectional view of a separation membrane complex (MOF membrane complex).

FIG. 2 is a sectional view showing part of the separation membrane complex in enlarged dimensions.

FIG. 3A is a diagram showing an X-ray diffraction pattern of CAU-10-H.

FIG. 3B is a diagram showing an X-ray diffraction pattern of CAU-10—NH₂.

FIG. 3C is a diagram showing an X-ray diffraction pattern of CAU-10-CH₃.

FIG. 3D is a diagram showing an X-ray diffraction pattern of CAU-10-NO₂.

FIG. 3E is a diagram showing an X-ray diffraction pattern of CAU-10-OCH₃.

FIG. 3F is a diagram showing an X-ray diffraction pattern of CAU-10-OH.

FIG. 4 is a flowchart showing the production of the separation membrane complex.

FIG. 5 is a diagram showing Solvothermal synthesis.

FIG. 6 is a diagram showing a separation apparatus.

FIG. 7 is a flowchart showing the separation of a mixture of substances by the separation apparatus.

### DETAILED DESCRIPTION

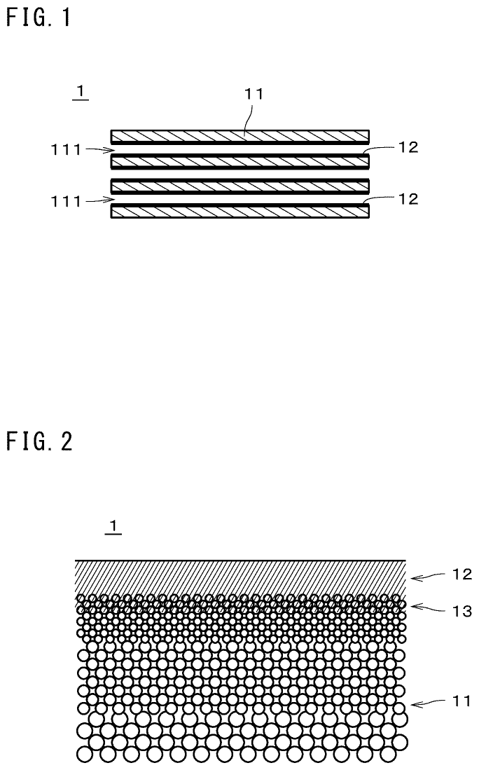

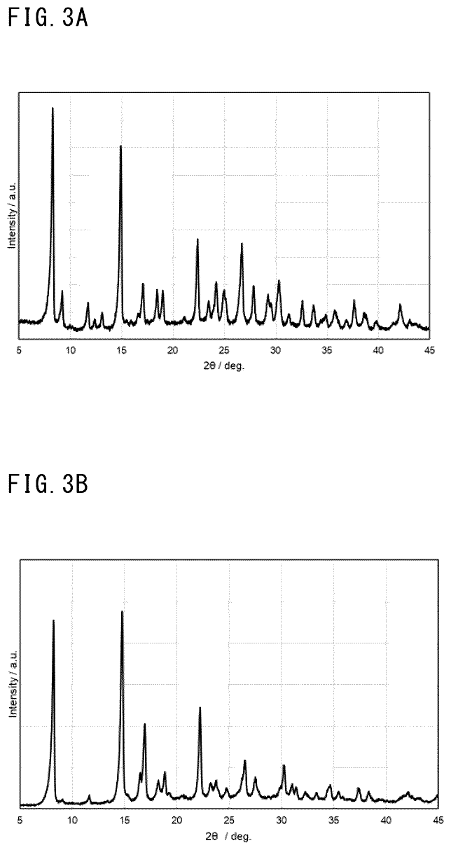

FIG. 1 is a sectional view of an MOF membrane complex 1 that includes a membrane of a metal-organic framework (MOF)(hereinafter also referred to as an “MOF membrane”). In the present embodiment, the MOF membrane complex 1 is used to separate a specific fluid and is thus hereinafter referred to as the “separation membrane complex 1”, but the use of the MOF membrane complex 1 is not limited to separating a specific fluid. FIG. 2 is a sectional view showing part of the separation membrane complex 1 in enlarged dimensions. The separation membrane complex 1 includes a support 11 that is porous and a separation membrane 12 that is an MOF membrane provided on the support 11. The MOF membrane refers to at least an MOF formed in membrane form on a surface of the support 11, and does not include MOFs in which MOF particles are simply dispersed in organic membranes. In FIG. 1, the separation membrane 12 is illustrated with thick lines in an emphasized manner. In FIG. 2, hatching is given to the separation membrane 12. The separation membrane 12 in FIG. 2 is illustrated thicker than its actual thickness.

The support 11 is a porous member that is permeable to gases and liquids. In the example shown in FIG. 1, the support 11 is a so-called monolith support in which a plurality of through holes 111, each extending in a longitudinal direction (i.e., the right-left direction in FIG. 1), are formed into an integrally-molded column-like body. In the example shown in FIG. 1, the support 11 has an approximately column-like shape. Each through hole 111 (i.e., cell) has, for example, an approximately circular shape in a cross section perpendicular to the longitudinal direction. In FIG. 1, the diameter of the through holes 111 is illustrated greater than the actual diameter, and the number of through holes 111 is illustrated smaller than the actual number. The separation membrane 12 is formed on the inner surfaces of the through holes 111 and covers approximately the entire inner surfaces of the through holes 111.

The length of the support 11 (i.e., the length in the right-left direction in FIG. 1) is in the range of, for example, 10 cm to 200 cm (here, “to” means values greater than or equal to the former value and less than or equal to the latter value). The outside diameter of the support 11 is in the range of, for example, 0.5 cm to 30 cm. The distance between the central axes of adjacent through holes 111 is in the range of, for example, 0.3 mm to 10 mm. Surface roughness (Ra) of the support 11 is in the range of, for example, 0.1 μm to 5.0 μm and preferably in the range of 0.2 μm to 2.0 μm. Note that the support 11 may have any other shape such as a honeycomb shape, a flat plate-like shape, a tube-like shape, a cylinder-like shape, a column-like shape, or a prism shape. In the case where the support 11 has a tube- or cylinder-like shape, the thickness of the support 11 is in the range of, for example, 0.1 mm to 10 mm.

The support 11 is formed of ceramic. Examples of a ceramic sintered body selected as the material for the support 11 include alumina, silica, mullite, zirconia, titania, yttria, silicon nitride, and silicon carbide. In the present embodiment, the support 11 contains at least one type selected from among alumina, silica, and mullite. The support 11 may contain an inorganic binder. The inorganic binder that can be used may be at least one selected from among titania, mullite, easily sinterable alumina, silica, glass frit, clay minerals, and easily sinterable cordierite.

The support 11 has a mean pore diameter of, for example, 0.01 μm to 70 μm and preferably 0.05 μm to 25 μm. The mean pore diameter of the support 11 in the vicinity of the surface on which the separation membrane 12 is formed is in the range of 0.01 μm to 1 μm and preferably in the range of 0.05 μm to 0.5 μm. The mean pore diameter may be measured by, for example, a mercury porosimeter, a perm-porosimeter, or a nano-perm-porosimeter. As to the pore size distribution of the entire support 11 including the surface and the interior, D5 is in the range of, for example, 0.01 μm to 50 μm, D50 is in the range of, for example, 0.05 μm to 70 μm, and D95 is in the range of, for example, 0.1 μm to 2000 μm. The porosity of the support 11 in the vicinity of the surface on which the separation membrane 12 is formed is in the range of, for example, 20% to 60%. The porosity can be obtained as the ratio of areas where space exists in an SEM (scanning electron microscope) image of a cross section of the support 11.

For example, the support 11 may have a multilayer structure in which a plurality of layers having different mean pore diameters are stacked one above another in the thickness direction. A mean particle diameter and a sintered particle diameter in the surface layer including the surface on which the separation membrane 12 is formed are smaller than those in layers other than the surface layer. The mean pore diameter in the surface layer of the support 11 is in the range of, for example, 0.01 μm to 1 μm and preferably in the range of 0.05 μm to 0.5 μm. In the case where the support 11 has a multilayer structure, any of the substances described above may be used as the material for each layer. The plurality of layers forming the multilayer structure may be made of the same material, or may be made of different materials. In the case where the support 11 has a multilayer structure, the mean pore diameter of the support 11 refers to the mean pore diameter in the surface layer including the surface on which the separation membrane 12 is formed.

The separation membrane 12 is a membrane of a CAU-10 MOF and is a porous membrane having fine pores (micropores). The separation membrane 12 is capable of separating a specific substance from a mixture of a plurality of types of substances by using a molecular-sieving function or the like. The separation membrane 12 is less permeable to the other substances than to the specific substance. In other words, the permeance of the separation membrane 12 to the other substances is lower than the permeance of the separation membrane 12 to the aforementioned specific substance.

The separation membrane 12 has an average membrane thickness of less than or equal to 10 μm. This realizes high permeance. There are no particular limitations on the lower limit for the average membrane thickness of the separation membrane 12, but from the viewpoint of improving separation performance, the lower limit is preferably 0.5 μm and more preferably 0.7 μm. In the measurement of the average membrane thickness of the separation membrane 12, a cross section of the separation membrane 12 perpendicular to the surface thereof is exposed by, for example, cross-sectional polishing. In this cross section, a plurality of randomly determined fields of view (e.g., seven fields of view) are observed with an SEM. The SEM has a magnification of, for example, 5000×. An average membrane thickness (average field membrane thickness) of the separation membrane 12 in the fields of view is obtained as an average value of membrane thicknesses at appropriately selected five locations, and an arithmetical mean of the average field membrane thicknesses in the remaining fields of view except the fields of view that give maximum and minimum average field membrane thicknesses is acquired as the average membrane thickness of the separation membrane 12. Surface roughness (Ra) of the separation membrane 12 is, for example, less than or equal to 2 μm, preferably less than or equal to 1 μm, and more preferably less than or equal to 0.5 μm.

A mean pore diameter of the MOF membrane configuring the separation membrane 12 is greater than or equal to 0.3 nm and less than or equal to 0.7 nm. The “mean pore diameter of the MOF” refers to an arithmetical mean of the major and minor axes of pore openings derived theoretically from the framework structure of the MOF. Alternatively, the mean pore diameter may be obtained by acquiring the major and minor axes of pore openings by observation with a TEM (transmission electron microscope). To be precise, the major and minor axes of pore openings refer to lattice spacing of a lattice structure formed of metal ions and organic ligands and having high regularity. The MOF has a specific pore structure including a channel (pores) and a cage (internal space) depending on the structure type. The pore diameter as used herein refers to the pore size of the channel, and an arithmetical mean of the major and minor axes is given as the mean pore diameter, where the major axis is a maximum diameter of the channel in a cross section, and the minor axis is the diameter of a cross section in a direction approximately perpendicular to the major axis. This mean pore diameter is smaller than the mean pore diameter of the support 11 in the vicinity of the surface on which the separation membrane 12 is formed.

A mean particle size of the MOF configuring the separation membrane 12, i.e., a mean diameter of crystal grains, is in the range of, for example, 0.1 μm to 2 μm. The mean particle size is preferably less than or equal to 1 μm and more preferably less than or equal to 0.5 μm. The separation membrane 12 with a small mean particle size of the MOF can reduce intergranular defects that may be caused by excessively large interstices between crystals of the MOF and can exhibit improved separation performance. The mean particle size of the MOF according to the present embodiment is an arithmetical mean of maximum diameters of a plurality of MOF particles (e.g., 30 particles) measured by observation of a membrane surface with an SEM. The particles to be measured may be randomly selected from an SEM image.

At the interface between the separation membrane 12 and the support 11, a composite layer 13 is formed, in which the crystals of the MOF become embedded in the pores of the support 11. FIG. 2 shows the composite layer 13 with hatching drawn over part of the support 11. The composite layer 13 is part of the support 11. The composite layer 13 has a thickness of, for example, less than or equal to 2 μm. This enables suppressing a decrease in permeance due to the presence of the composite layer 13. The composite layer 13 may be omitted; that is, the lower limit value for the thickness of the composite layer 13 is zero.

In the measurement of the thickness of the composite layer 13, a boundary position of the composite layer 13 in a direction perpendicular to the interface between the support 11 and the separation membrane 12 (hereinafter referred to as a “depth direction”) is identified in the vicinity of one measurement position in a direction along the interface during observation of the cross section with an SEM. To be more specific, the boundary position of the composite layer 13 on the side closer to the separation membrane 12 corresponds to the interface between the separation membrane 12 and the support 11. The boundary position of the composite layer 13 on the side opposite to the separation membrane 12 corresponds to, in the MOF existing within the pores of the support 11, the edge of the MOF that is furthest from the separation membrane 12 in the depth direction. The distance in the depth direction between the boundary position of the composite layer 13 on the side closer to the separation membrane 12 and the boundary position thereof on the side opposite to the separation membrane 12 is acquired as the thickness of the composite layer 13 at the measurement position. Then, an average of the thicknesses of the composite layer 13 at a plurality of different measurement positions (e.g., 10 measurement positions) is determined as the thickness of the composite layer 13 in the separation membrane complex 1.

Not only in the case where the composite layer 13 does not exist, but also in the case where the composite layer 13 exists, there is no additional intermediate layer formed between the support 11 and the separation membrane 12 in the separation membrane complex 1. Thus, the support 11 and the separation membrane 12 are in direct contact with each other. That is, there is no intermediate layer formed between the support 11 and the separation membrane 12 in any step other than the step of forming the MOF membrane. This structure is merely one example, and for example, the support 11 may include an intermediate layer formed separately on a basic portion, and the separation membrane 12 may be provided on this intermediate layer.

The MOF configuring the separation membrane 12 contains metal ions and organic ligands (hereinafter simply referred to as “ligands”) coordinated with the metal ions. The metal ions serving as a component of the CAU-10 MOF is Al³⁺ (aluminum ions). The ligands serving as a component of the CAU-10 MOF is, for example, any one selected from isophthalic acid (benzene-1,3-dicarboxylic acid), 5-amino isophthalic acid, 5-methyl isophthalic acid, 5-methoxy isophthalic acid, 5-nitro isophthalic acid, and 5-hydroxy isophthalic acid. The ligands do not necessarily have to be of one type, and multiple types of ligands may be used.

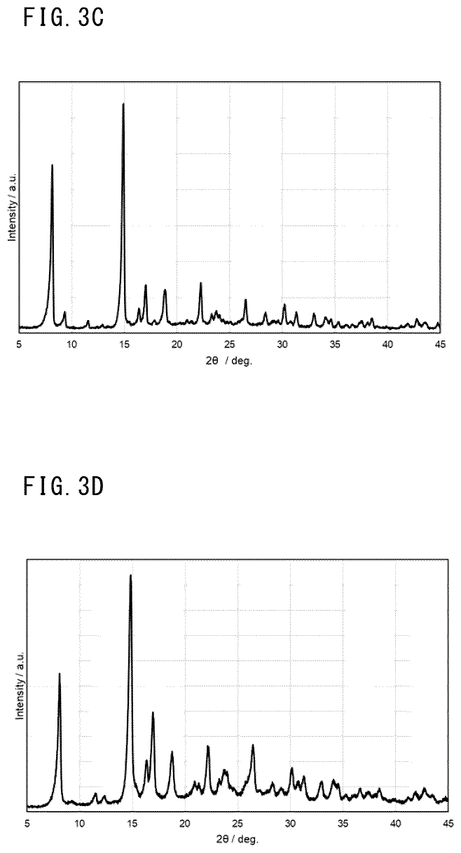

FIGS. 3A, 3B, 3C, 3D, 3E, and 3F are diagrams showing X-ray diffraction patterns of CAU-10-H, CAU-10—NH₂, CAU-10-CH₃, CAU-10-NO₂, CAU-10-OCH₃, and CAU-10-OH MOFs, respectively, obtained by an X-ray diffraction method. The horizontal axis indicates the diffraction angle (20/deg.), and the vertical axis indicates the intensity (Intensity a.u.). The X-ray diffraction patterns of the CAU-10 MOF have peaks in the vicinities of at least 2θ=8.1°, 14.8°, and 22.4°.

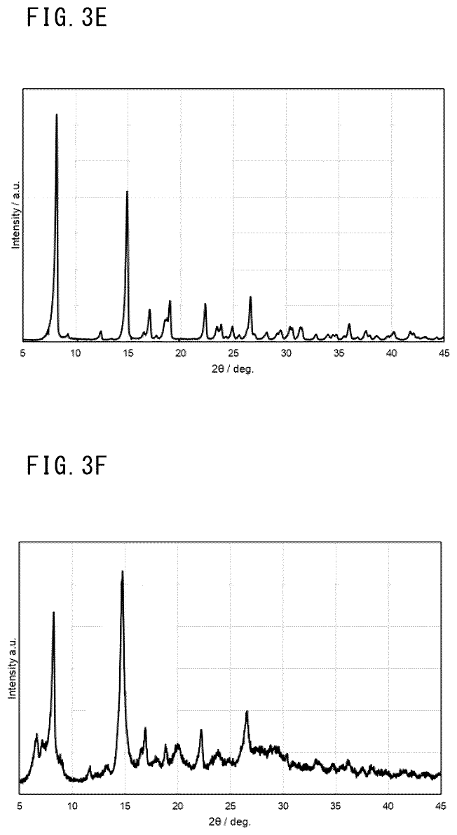

Next, a procedure for producing the separation membrane complex 1 is described with reference to FIG. 4. In the production of the separation membrane complex 1, first, seed crystals that are used to form the separation membrane 12 are prepared (step S11). The seed crystals have a CAU-10 MOF of the same type as an MOF membrane to be formed. Specifically, first, an aluminum ion source (Al ion source) and ligands are mixed in a solution that contains water and an organic solvent such as dimethylformamide (DMF) while stirring. After the solution is subjected to Solvothermal synthesis by heating, a resultant product is separated from the solution by centrifugal separation and cleaned with water and ethanol to obtain powder of the MOF. This powder is pulverized (ball milled) with zirconia (ZrO₂) beads in ethanol to obtain seed crystals. The powder of the MOF may be generated by any other known production method. The powder of the MOF may be used as-is as the seed crystals

A mean particle size (D50) of the seed crystals is preferably less than or equal to 0.5 μm. This suppresses the development of intergranular defects in the MOF membrane due to an excessive increase in the mean particle size of the MOF. There are no particular limitations on the lower limit for the mean particle size of the seed crystals, but for example, if the mean particle size is greater than or equal to 0.1 μm, it is possible to suppress deterioration in crystallinity of the seed crystals. The mean particle size (D50) of the seed crystals can be measured by, for example, a laser scattering method.

Then, the seed crystals are dispersed in a solvent (water and/or an organic solvent) to produce a fluid dispersion in an amount of 0.01 w % to 1 w %. The support 11 that is porous is immersed in the fluid dispersion so that the seed crystals are deposited on the support 11 (dip coating)(step S12). Alternatively, the fluid dispersion with the seed crystals dispersed in the solvent may be applied to a portion of the support 11 on which the separation membrane 12 is to be formed, in order to deposit the seed crystals on the support 11. Thereafter, the solvent is removed by drying to prepare a seed-crystal-deposited support. Note that any other technique may be used to deposit the seed crystals on the support 11.

Then, a starting material solution (also referred to as synthetic sol or a synthetic solution) that is used to form the MOF membrane is confected and prepared (steps S13a and S13b). The confection of the starting material solution may be conducted before step S12 or in parallel with step S12. In the confection of the starting material solution, a solvent (water and/or an organic solvent), ligands, a metal ion source, and other starting materials as required are mixed together, and they are mixed in a given order.

Specifically, a solution in which an Al ion source dissolves in water (i.e., ion-exchanged water)(the solution is hereinafter referred to as the “Al source solution”) is generated (step S13a). In this way, the Al source solution is prepared. For example, aluminum nitrate nonahydrate, aluminum chloride hexahydrate, aluminum sulfate 14-18 waters, or aluminum hydroxide may be used as the Al ion source. Then, a solution in which ligands dissolve in an organic solvent (the solution is hereinafter referred to as the “ligand solution”) is generated (step S13b). In this way, the ligand solution is prepared. The ligands correspond to the type of the CAU-10 MOF and is, for example, isophthalic acid (benzene-1,3-dicarboxylic acid), 5-amino isophthalic acid, 5-methyl isophthalic acid, 5-methoxy isophthalic acid, 5-nitro isophthalic acid, or 5-hydroxy isophthalic acid. The organic solvent is, for example, DMF, diethylformamide (DEF), or methanol. Steps S13a and S13b may be performed in an arbitrary order, and may be performed in parallel.

Then, the ligand solution is gradually added to the Al source solution while stirring the Al source solution (step S14). At this time, if the ligand solution is added all at once to the Al source solution, the resultant mixed solution becomes cloudy. Thus, the ligand solution is mixed into the Al source solution at a rate that does not cause cloudiness in order to generate a starting material solution. In this way, the starting material solution that is not cloudy is prepared. In step S14, preferably, the ligand solution is added dropwise to the Al source solution while stirring. The drop rate is preferably set to be higher than or equal to 0.01 g per second and lower than or equal to 0.5 g per second in order to more reliably obtain the clear starting material solution. The phenomenon that the mixed solution becomes cloudy when the ligand solution is added all at once to the Al source solution is thought to be due to the fact that the ligands precipitate without dissolving in water, so that the mixed solution is in an incomplete mixture state. If stirring is stopped, such an incomplete starting material solution will settle downward over time. That is, in the description of the present invention, the phrase saying that the solution is not cloudy refers to a state in which there are no sediments at the bottom even if stirring is stopped, and does not depend on the clearness of the solution.

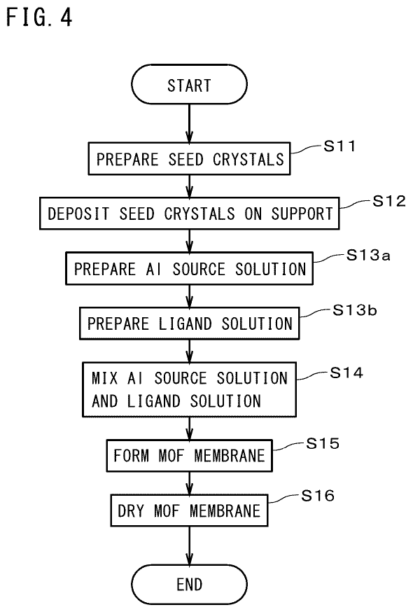

Once the starting material solution is prepared, the support 11 with the seed crystals deposited thereon is immersed in a starting material solution 51 in a container 52 as shown in FIG. 5. In the starting material solution 51, the support 11 is supported by a support frame which is not shown, and does not come in contact with the bottom surface of the container 52. In the case where the support 11 is of a so-called monolith type having a plurality of parallel through holes 111, the support 11 is immersed in the starting material solution 51 in a state in which the direction of extension of the through holes 111 is parallel to the vertical direction, in order to reduce differences in conditions among the through holes 111. Here, if the starting material solution used is cloudy, the cloudiness concentration will become higher in the lower part of the container 52 which stores the starting material solution 51. This causes differences in MOF production conditions between the upper and lower parts of the through holes 11 during subsequent Solvothermal synthesis. As a result, the MOF membrane with an inadequate thickness may be formed in the upper parts of the through holes 111 even though the MOF membrane formed in the lower parts of the through holes 111 have an appropriate thickness.

In contrast, in the case where the starting material solution 51 that is generated as not being cloudy in steps S13a, S13b, and S14 is used, there is little difference in MOF production conditions between the upper and lower parts of each through hole 111. This enables forming the MOF membrane with a uniform thickness on the entire surface of each through hole 111 and on all of the through holes 111. That is, it is possible to form the membrane of the CAU-10 MOF with little variation in thickness inside each through hole 111 and little variation in thickness among the plurality of through holes. Note that similar effects can also be achieved even if the support 11 has a shape other than the monolith-type shape.

Thereafter, the starting material solution is heated to initiate Solvothermal synthesis (also referred to as hydrothermal synthesis when the solvent is water). In the Solvothermal synthesis, the CAU-10 MOF grows using the seed crystals as nuclei, and a dense MOF membrane is formed as the separation membrane 12 on the support 11 (step S15). The MOF membrane is any of the membranes of CAU-10-H, CAU-10—NH₂, CAU-10-CH₃, CAU-10-OCH₃, CAU-10-NO₂, and CAU-10-OH (see “BACKGROUND ART”). The synthesis temperature (the temperature of heating the starting material solution) during the Solvothermal synthesis is in the range of, for example, 80° C. to 180° C. and preferably in the range of 110° C. to 140° C. The Solvothermal synthesis time is in the range of, for example, 2 hours to 72 hours and preferably in the range of 3 hours to 35 hours.

After the Solvothermal synthesis is completed, the support 11 and the MOF membrane are cleaned with ion-exchanged water and then cleaned with ethanol, methanol, or the like. Preferably, cleaning with water and ethanol, methanol, or the like may be repeated multiple times. The support 11 and the MOF membrane after cleaning are dried at a temperature of, for example, 60° C. to 100° C. (step S16). The phrase saying “being dried” as used herein refers to removing, from the insides of the pores of the MOF membrane, molecules of substances used for cleaning with water and ethanol, methanol, or the like. By this drying, the separation membrane complex 1 is completed.

In the above-described method of producing the separation membrane complex 1, a clear solution can be obtained as the starting material solution for the MOF membrane. Thus, it is possible to obtain the MOF membrane complex that includes the membrane of the CAU-10 MOF with little variation in thickness. It is also possible to obtain the MOF membrane complex that includes the membrane of a variety of CAU-10 MOFs.

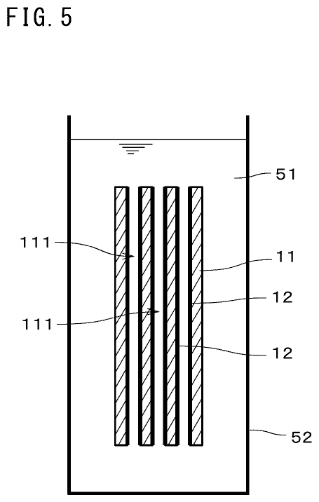

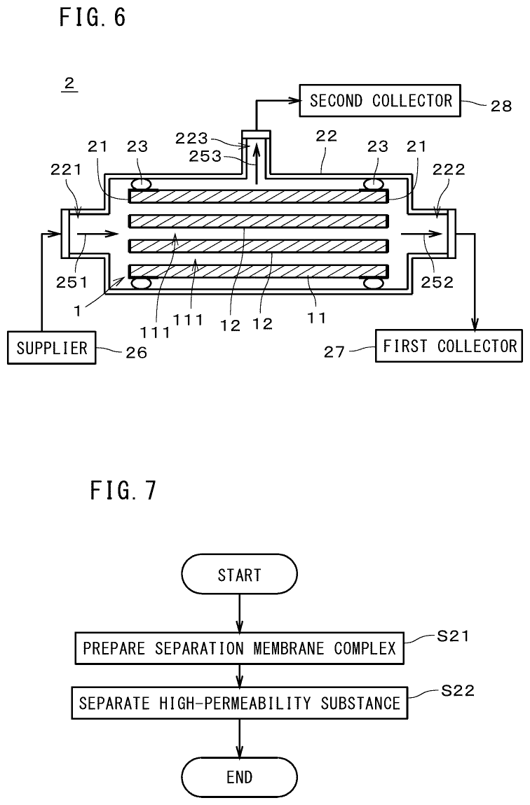

Next, the separation of a mixture of substances using the separation membrane complex 1 is described with reference to FIGS. 6 and 7. FIG. 6 is a diagram showing a separation apparatus 2. FIG. 7 is a flowchart showing the separation of a mixture of substances by the separation apparatus 2.

The separation apparatus 2 supplies a mixture of substances including a plurality of types of fluid (i.e., gases or liquids) to the separation membrane complex 1 and causes a substance with high permeability in the mixture of substances to permeate the separation membrane complex 1 in order to separate the substance with high permeability from the mixture of substances. For example, the separation by the separation apparatus 2 may be performed for the purpose of extracting a substance with high permeability from the mixture of substances or for the purpose of condensing a substance with low permeability.

The mixture of substances (i.e., a fluid mixture) may be a mixed gas that contains a plurality of types of gases, a mixed solution that contains a plurality of types of liquids, or a gas-liquid two-phase fluid that contains both a gas and a liquid.

For example, the mixture of substances may contain one or more types of substances selected from among hydrogen (H₂), helium (He), nitrogen (N₂), oxygen (O₂), water (H₂O), carbon monoxide (CO), carbon dioxide (CO₂), nitrogen oxides, ammonia (NH₃), sulfur oxides, hydrogen sulfide (H₂S), sulfur fluorides, mercury (Hg), arsine (AsH₃), hydrogen cyanide (HCN), carbonyl sulfide (COS), C1 to C8 hydrocarbons, organic acids, alcohol, mercaptans, ester, ether, ketone, and aldehyde.

Nitrogen oxides are compounds of nitrogen and oxygen. For example, the aforementioned nitrogen oxides may be gases called NOx such as nitrogen monoxide (NO), nitrogen dioxide (NO₂), nitrous oxide (also referred to as dinitrogen monoxide)(N₂O), dinitrogen trioxide (N₂O₃), dinitrogen tetroxide (N₂O₄), or dinitrogen pentoxide (N₂O₅).

Sulfur oxides are compounds of sulfur and oxygen. For example, the aforementioned sulfur oxides may be gases called SOₓ such as sulfur dioxide (SO₂) or sulfur trioxide (SO₃).

Sulfur fluorides are compounds of fluorine and sulfur. For example, the aforementioned sulfur fluorides may be disulfur difluoride (F—S—S—F, S═SF₂), sulfur difluoride (SF₂), sulfur tetrafluoride (SF₄), sulfur hexafluoride (SF₆), or disulfur decafluoride (S₂F₁₀).

C1 to C8 hydrocarbons are hydrocarbons that contain one or more and eight or less carbon atoms. C3 to C8 hydrocarbons may be any of linear-chain compounds, side-chain compounds, and cyclic compounds. C2 to C8 hydrocarbons each may be one of saturated hydrocarbons (i.e., where neither double bonds nor triple bonds exist in molecules) and unsaturated hydrocarbons (i.e., where double bonds and/or triple bonds exist in molecules). C1 to C4 hydrocarbons may, for example, be methane (CH₄), ethane (C₂H₆), ethylene (C₂H₄), propane (C₃H₈), propylene (C₃H₆), normal butane (CH₃(CH₂)₂CH₃), isobutene (CH(CH₃)₃), 1-butene (CH₂═CHCH₂CH₃), 2-butene (CH₃CH═CHCH₃), or isobutene (CH₂═C(CH₃)₂).

The aforementioned organic acids may, for example, be carboxylic acids or sulfonic acids. The carboxylic acids may, for example, be formic acid (CH₂O₂), acetic acid (C₂H₄O₂), oxalic acid (C₂H₂O₄), acrylic acid (C₃H₄O₂), or benzoic acid (C₆H₅COOH). The sulfonic acids may, for example, be ethane sulfonic acid (C₂H₆O₃S). The organic acids may be either chain compounds or cyclic compounds.

The aforementioned alcohol may, for example, be methanol (CH₃OH), ethanol (C₂H₅OH), isopropanol (2-propanol)(CH₃CH(OH)CH₃), ethylene glycol (CH₂(OH)CH₂(OH)), or butanol (C₄H₉OH).

Mercaptans are organic compounds with terminal sulfur hydrides (SH) and are also substances called thiol or thioalcohol. The aforementioned mercaptans may, for example, be methyl mercaptan (CH₃SH), ethyl mercaptan (C₂H₅SH), or 1-propane thiol (C₃H₇SH).

The aforementioned ester may, for example, be formic acid ester or acetic acid ester.

The aforementioned ether may, for example, be dimethyl ether ((CH₃)₂O), methyl ethyl ether (C₂H₅OCH₃), or diethyl ether ((C₂H₅)₂O).

The aforementioned ketone may, for example, be acetone ((CH₃)₂CO), methyl ethyl ketone (C₂H₅COCH₃), or diethyl ketone ((C₂H₅)₂CO).

The aforementioned aldehyde may, for example, be acetaldehyde (CH₃CHO), propionaldehyde (C₂H₅CHO), or butanal (butyraldehyde)(C₃H₇CHO).

The following description is given on the assumption that a mixture of substances to be separated by the separation apparatus 2 is a mixed gas that contains a plurality of types of gases.

The separation apparatus 2 includes the separation membrane complex 1, sealers 21, a housing 22, two seal members 23, a supplier 26, a first collector 27, and a second collector 28.

The separation membrane complex 1, the sealers 21, and the seal members 23 are placed in the housing 22. The supplier 26, the first collector 27, and the second collector 28 are arranged outside the housing 22 and connected to the housing 22.

The sealers 21 are members that are attached to both ends of the support 11 in the longitudinal direction (i.e., the right-left direction in FIG. 6) and cover and seal both end faces of the support 11 in the longitudinal direction and the outer surface thereof in the vicinity of the both end faces. The sealers 21 prevent an inflow and outflow of gases from the both end faces of the support 11. For example, the sealer 21 may be a plate-like member formed of glass or a resin. The material and shape of the sealer 21 may be changed as appropriate. Note that the sealer 21 has a plurality of openings that overlap the through holes 111 of the support 11, so that both ends of each through hole 111 of the support 11 in the longitudinal direction are not covered with the sealer 21. This allows the inflow and outflow of gases or the like from the both ends into and out of the through holes 111.

There are no particular limitations on the shape of the housing 22, and the housing 22 is, for example, an approximately cylinder-like tubular member. The housing 22 is formed of, for example, stainless steel or carbon steel. The longitudinal direction of the housing 22 is approximately parallel to the longitudinal direction of the separation membrane complex 1. One end of the housing 22 in the longitudinal direction (i.e., the left end in FIG. 6) is provided with a supply port 221, and the other end thereof is provided with a first exhaust port 222. The side face of the housing 22 is provided with a second exhaust port 223. The supply port 221 is connected to the supplier 26. The first exhaust port 222 is connected to the first collector 27. The second exhaust port 223 is connected to the second collector 28. The internal space of the housing 22 is an enclosed space isolated from the space around the housing 22.

The two seal members 23 are arranged around the entire circumference between the outer surface of the separation membrane complex 1 and the inner surface of the housing 22 in the vicinity of the both ends of the separation membrane complex 1 in the longitudinal direction. Each seal member 23 is an approximately ring-shaped member formed of a material that is impermeable to gases. For example, the seal members 23 may be O-rings formed of a resin having flexibility. The seal members 23 are in tight contact with the outer surface of the separation membrane complex 1 and the inner surface of the housing 22 along the entire circumference. In the example shown in FIG. 6, the seal members 23 are in tight contact with the outer surfaces of the sealers 21 and are in indirect tight contact with the outer surface of the separation membrane complex 1 via the sealers 21. The space between the seal members 23 and the outer surface of the separation membrane complex 1 and the space between the seal members 23 and the inner surface of the housing 22 are sealed so as to almost or completely disable the passage of gases.

The supplier 26 supplies a mixed gas to the internal space of the housing 22 via the supply port 221. For example, the supplier 26 is a blower or a pump that sends the mixed gas toward the housing 22 under pressure. The blower or the pump includes a pressure regulator that regulates the pressure of the mixed gas supplied to the housing 22. The first collector 27 and the second collector 28 are, for example, reservoirs that store gases derived from the housing 22, or a blower or a pump that transfers the gases.

In the separation of the mixed gas, the above-described separation apparatus 2 is prepared for the preparation of the separation membrane complex 1 (step S21). Then, the supplier 26 supplies a mixed gas to the internal space of the housing 22, the mixed gas containing a plurality of types of gases each having different permeability through the separation membrane 12. For example, principal components of the mixed gas are CO₂ and N₂. The mixed gas may further contain a gas other than CO₂ and N₂. The pressure of the mixed gas supplied from the supplier 26 to the internal space of the housing 22 (i.e., initial pressure) is in the range of, for example, 0.1 MPa to 20.0 MPa. The temperature during the separation of the mixed gas is in the range of, for example, 10° C. to 150° C.

The mixed gas supplied from the supplier 26 to the housing 22 is introduced from the left end of the separation membrane complex 1 in the drawing into each through hole 111 of the support 11 as indicated by an arrow 251. A gas with high permeability in the mixed gas (e.g., CO₂; hereinafter referred to as a “high-permeability substance”) permeates the separation membrane 12 provided on the inner surface of each through hole 111 and then permeates the support 11 so as to be derived from the outer surface of the support 11. Accordingly, the high-permeability substance is separated from a gas with low permeability in the mixed gas (e.g., N₂; hereinafter referred to as a “low-permeability substance”)(step S22). The gas derived from the outer surface of the support 11 (hereinafter, referred to as a “permeated substance”) is collected by the second collector 28 via the second exhaust port 223 as indicated by an arrow 253. The pressure of the gas collected by the second collector 28 via the second exhaust port 223 (i.e., permeate pressure) is, for example, approximately one atmospheric pressure (0.101 MPa).

In the mixed gas, gases (hereinafter, referred to as “non-permeated substances”) other than the gas that has permeated the separation membrane 12 and the support 11 pass through each through hole 111 of the support 11 from the left side to the right side in the drawing and is collected by the first collector 27 via the first exhaust port 222 as indicated by an arrow 252. The pressure of the gas collected by the first collector 27 via the first exhaust port 222 is, for example, approximately the same as the initial pressure. The non-permeated substances may include, in addition to the aforementioned low-permeability substance, a high-permeability substance that has not permeated the separation membrane 12.

Next, examples and comparative examples of the separation membrane complex are described. Table 1 shows production conditions and measurement results for the examples and the comparative examples.

TABLE 1

| | | | | Molar | Average | | |
|---|---|---|---|---|---|---|---|
| | | pH | | Ratio of | Membrane | In-Hole | Inter-Hole |
| | Type of | Before | After | Solvent | Thickness | Evaluation | Evaluation |
| | CAU-10 | Mixing | Mixing | to Ligand | (μm) | Value | Value |
| Example 1-1 | CAU-10-H | 3.4 | 3.5 | 394 | 0.5 | 14 | 10 |
| Example 1-2 | CAU-10-H | 3.6 | 3.7 | 788 | 0.3 | 29 | 28 |
| Example 2-1 | CAU-10-NH₂ | 2.8 | 2.6 | 41 | 0.9 | 11 | 10 |
| Example 2-2 | CAU-10-NH₂ | 2.8 | 2.5 | 41 | 1.3 | 14 | 15 |
| Example 2-3 | CAU-10-NH₂ | 2.8 | 2.6 | 41 | 1.2 | 17 | 12 |
| Example 2-4 | CAU-10-NH₂ | 3.1 | 2.8 | 41 | 2.3 | 14 | 25 |
| Example 3 | CAU-10-CH₃ | 3.1 | 2.9 | 123 | 3.9 | 22 | 20 |
| Example 4 | CAU-10-NO₂ | 3.3 | 3.0 | 193 | 2.5 | 15 | 10 |
| Example 5 | CAU-10-OCH₃ | 3.1 | 2.9 | 193 | 2.5 | 10 | 12 |
| Example 6 | CAU-10-OH | 3.2 | 3.0 | 193 | 2.3 | 13 | 16 |
| Comparative | CAU-10-NH₂ | 2.8 | 2.6 | 41 | 0.9 | 40 | 31 |
| Example 1 | | | | | | | |
| Comparative | CAU-10-NH₂ | 2.1 | 1.8 | 8 | 4.6 | 35 | 31 |
| Example 2 | | | | | | | |

### Example 1-1: CAU-10-H

### Preparation of Seed Crystals

A mixed solution was prepared by adding 1.43 g of aluminum sulfate 14-18 water serving as an Al ion source and 0.71 g of isophthalic acid serving as a ligand to a mixed solvent of 14 g of ion-exchanged water and 3.5 g of N, N-dimethylformamide (DMF). Then, the mixed solution was subjected to Solvothermal synthesis at 120° C. for 12 hours. Precipitates were separated by a centrifugal separator and cleaned three times with ion-exchanged water and ethanol to obtain seed crystals of CAU-10-H.

### Support of Seed Crystals

One gram of the seed crystals of CAU-10-H was dispersed into 10 mL of ethanol and pulverized in a ball mill for 24 hours to obtain a fluid dispersion of the seed crystals with a mean particle diameter (D50) of 250 nm. After this, ethanol was added to the fluid dispersion to achieve a concentration of 0.01%. A porous alumina support was immersed in this fluid dispersion to deposit the fluid dispersion on the support, and the solvent was volatilized in a dryer to support the seed crystals on the surface of the support. The support used had a mean pore diameter of about 100 nm.

### Formation of MOF Membrane

First, a starting material solution was prepared by slowly mixing a solution obtained by adding isophthalic acid serving as a ligand to DMF (ligand solution), dropwise into a solution obtained by adding sodium formate and aluminum sulfate 14-18 water serving as an Al ion source to ion-exchanged water (Al source solution) while stirring. The molar ratio of aluminum sulfate 14-18 water, isophthalic acid, sodium formate, ion-exchanged water, and DMF was set to 1:1:2:6394:394. The Al source solution before the start of mixing had a pH of 3.4, and the starting material solution after the end of mixing had a pH of 3.5. The starting material solution was clear.

Then, the starting material solution and the support with the seed crystals deposited thereon were placed in a container made of Teflon (registered trademark) and was subjected to Solvothermal synthesis at 130° C. for 12 hours to obtain an MOF membrane complex in which a CAU-10-H membrane was formed on the support. This MOF membrane complex was cleaned three times with ion-exchanged water and ethanol. Thereafter, the MOF membrane complex was dried at 80° C. for 12 hours.

### Result of Measuring Membrane Thickness

A longitudinal cross section of the MOF membrane was observed in seven randomly selected fields of view with an SEM (scanning electron microscope). As already described, an average membrane thickness of the MOF membrane in each field image (average field thickness) was obtained, and an arithmetic mean of average field thicknesses for five fields of view, excluding the fields of view that gave maximum and minimum average field thicknesses, was determined as the average membrane thickness of the MOF membrane. The same also applied to the examples and the comparative examples described below.

As a result of the measurement by the above-described technique, the average membrane thickness of the MOF membrane according to Example 1-1 was 0.5 μm.

### Result of Measuring In-Hole Evaluation Value

The support was divided into three equal parts in the longitudinal direction along which the through holes extend, and an image of a longitudinal cross section of the MOF membrane within one through hole was acquired with an SEM at the center of each part in the longitudinal direction (which does not necessarily have to be exactly the center as long as it is approximately the center). In each of the three images acquired, the membrane thickness of the MOF membrane was obtained by measuring the distance between an arbitrary point on the membrane surface and a point at the interface, between the MOF membrane and the support, existing in a direction perpendicular to the arbitrary point. An average value of the three membrane thicknesses was obtained as an “in-hole average membrane thickness value”, and differences (to be precise, absolute values of differences) between each of the three membrane thicknesses and the in-hole average membrane thickness value were obtained. The ratio of a maximum value out of the differences to the in-hole average membrane thickness value was obtained as an in-hole evaluation value. The same also applied to the examples and the comparative examples described below. By obtaining the in-hole average membrane thickness value from the three membrane thicknesses, it is possible to obtain the average membrane thickness from as few images as possible, while taking into account the membrane thicknesses other than those at the center in the longitudinal direction.

The in-hole evaluation value according to Example 1-1 was 14%.

### Result of Measuring Inter-Hole Evaluation Value

Another through hole was selected, and the in-hole average membrane thickness value for this through hole was also obtained by the above-described technique. Then, an average value of the two in-hole average membrane thickness values was obtained as an inter-hole average membrane thickness value. Differences (to be precise, absolute values of differences) between the inter-hole average membrane thickness value and each of the in-hole average membrane thickness values for the two through holes were obtained, and the ratio of a maximum value out of the differences to the inter-hole average membrane thickness value was obtained as an inter-hole evaluation value. The same also applied to the examples and the comparative examples described below.

The inter-hole evaluation value according to Example 1-1 was 10%.

### Example 1-2: CAU-10-H

An MOF membrane complex was obtained in the same manner as in Example 1-1, except that the molar ratio of aluminum sulfate 14-18 water, isophthalic acid, sodium formate, ion-exchanged water, and DMF in the starting material solution used for the formation of the MOF membrane was set to 1:1:2:12788:788. The Al source solution before the start of mixing had a pH of 3.6, and the starting material solution after the end of mixing had a pH of 3.7. The starting material solution was clear. The average membrane thickness of the MOF membrane according to Example 1-2 was 0.3 μm. The in-hole evaluation value was 29%. The inter-hole evaluation value was 28%.

### Example 2-1: CAU-10—NH₂

### Preparation of Seed Crystals

A mixed solution was prepared by adding 0.16 g of aluminum chloride hexahydrate serving as an Al ion source and 0.24 g of 5-amino isophthalic acid serving as a ligand to a mixed solvent of 16 g of ion-exchanged water and 4 g of N, N-dimethylformamide (DMF). Then, the mixed solution was subjected to Solvothermal synthesis at 120° C. for 12 hours. Precipitates were separated by a centrifugal separator and cleaned three times with ion-exchanged water and ethanol to obtain seed crystals of CAU-10—NH₂.

### Support of Seed Crystals

A support that supported the seed crystals was obtained in the same manner as in Example 1-1, except that CAU-10—NH₂ was used as the seed crystals.

### Formation of MOF Membrane

First, a starting material solution was prepared by slowly mixing a solution obtained by adding 5-amino isophthalic acid serving as a ligand to DMF (ligand solution), dropwise into a solution obtained by adding aluminum chloride hexahydrate serving as an Al ion source to ion-exchanged water (Al source solution) while stirring. The molar ratio of aluminum chloride hexahydrate, 5-amino isophthalic acid, ion-exchanged water, and DMF was set to 1:1:670:41. The Al source solution before the start of mixing had a pH of 2.8, and the starting material solution after the end of mixing had a pH of 2.6. The starting material solution was clear.

Then, the starting material solution and the support with the seed crystals deposited thereon were placed in a container made of Teflon (registered trademark) and was subjected to Solvothermal synthesis at 130° C. for 12 hours to obtain an MOF membrane structure in which a CAU-10—NH₂ membrane was formed on the support. This MOF membrane complex was cleaned three times with ion-exchanged water and ethanol. Thereafter, the MOF membrane complex was dried at 80° C. for three hours. Furthermore, the MOF membrane complex was cleaned once with methanol and dried at ambient temperature.

### Measurement Results

The average membrane thickness of the MOF membrane according to Example 2-1 was 0.9 μm. The in-hole evaluation value was 11%. The inter-hole evaluation value was 10%.

### Example 2-2: CAU-10—NH₂

An MOF membrane complex was obtained in the same manner as in Example 2-1, except that aluminum nitrate nonahydrate was used as the Al ion source. The Al source solution before the start of mixing had a pH of 2.8, and the starting material solution after the end of mixing had a pH of 2.5. The starting material solution was clear. The average membrane thickness of the MOF membrane according to Example 2-2 was 1.3 μm. The in-hole evaluation value was 14%. The inter-hole evaluation value was 15%.

### Example 2-3: CAU-10—NH₂

An MOF membrane complex was obtained in the same manner as in Example 2-1, except that the temperature during the Solvothermal synthesis for forming the MOF membrane was set to 140° C. The average membrane thickness of the MOF membrane according to Examples 2-3 was 1.2 μm. The in-hole evaluation value was 17%. The inter-hole evaluation value was 12%.

### Example 2-4: CAU-10—NH₂

An MOF membrane complex was obtained in the same manner as in Example 2-1, except that the molar ratio of aluminum chloride hexahydrate, 5-amino isophthalic acid, ion-exchanged water, and DMF in the starting material solution for forming the MOF membrane was set to 0.5:1:670:41. The Al source solution before the start of mixing had a pH of 3.1, and the starting material solution after the end of mixing had a pH of 2.8. The starting material solution was clear. The average membrane thickness of the MOF membrane according to Example 2-4 was 2.3 μm. The in-hole evaluation value was 14%. The inter-hole evaluation value was 25%.

### Example 3: CAU-10-CH₃

### Preparation of Seed Crystals

Seed crystals of CAU-10-CH₃ were obtained in the same manner as in Example 1-1, except that 0.77 g of 5-methyl isophthalic acid was used as the ligand.

### Support of Seed Crystals

A support that supported the seed crystals was obtained in the same manner as in Example 1-1, except that CAU-10-CH₃ was used as the seed crystals.

### Formation of MOF Membrane

A starting material solution was prepared in the same manner as in Example 1-1, except that 5-methyl isophthalic acid was used as the ligand, and sodium format was not added to the Al source solution. The molar ratio of aluminum sulfate 14-18 water, 5-methyl isophthalic acid, ion-exchanged water, and DMF was set to 1:1:2000:123. The Al source solution after the start of mixing had a pH of 3.1, and the starting material solution after the end of mixing had a pH of 2.9. The starting material solution was clear.

Then, the starting material solution and the support with the seed crystals deposited thereon were placed in a container made of Teflon (registered trademark) and was subjected to Solvothermal synthesis at 130° C. for 12 hours to obtain a MOF membrane complex in which a CAU-10-CH₃ membrane was formed on the support. This MOF membrane complex was cleaned three times with ion-exchanged water and ethanol. Thereafter, the MOF membrane complex was dried at 80° C. for three hours in a dryer.

The average membrane thickness of the MOF membrane according to Example 3 was 3.9 μm. The in-hole evaluation value was 22%. The inter-hole evaluation value was 20%.

### Example 4: CAU-10-NO₂

### Preparation of Seed Crystals

Seed crystals of CAU-10-NO₂ were obtained in the same manner as in Example 1-1, except that 0.28 g of 5-nitro isophthalic acid was used as the ligand.

### Support of Seed Crystals

A support that supported the seed crystals was obtained in the same manner as in Example 1-1, except that CAU-10-NO₂ was used as the seed crystals.

### Formation of MOF Membrane

A starting material solution was prepared in the same manner as in Example 2-1, except that 5-nitro isophthalic acid was used as the ligand. The molar ratio of aluminum chloride hexahydrate, 5-nitro isophthalic acid, ion-exchanged water, and DMF was set to 1:1:2352:193. The Al source solution before the start of mixing had a pH of 3.3, and the starting material solution after the end of mixing had a pH of 3.0. The starting material solution was clear.

Then, the starting material solution and the support with the seed crystals deposited thereon were placed in a container made of Teflon (registered trademark) and was subjected to Solvothermal synthesis at 130° C. for 12 hours to obtain an MOF membrane complex in which a CAU-10-NO₂ membrane was formed on the support. This MOF membrane complex was cleaned three times with ion-exchanged water and ethanol. Thereafter, the MOF membrane complex was dried at 80° C. for three hours in a dryer.

The average membrane thickness of the MOF membrane according to Example 4 was 2.5 μm. The in-hole evaluation value was 15%. The inter-hole evaluation value was 10%.

### Example 5: CAU-10-OCH₃

### Preparation of Seed Crystals

Seed crystals of CAU-10-OCH₃ were obtained in the same manner as in Example 1-1, except that 0.84 g of 5-methoxy isophthalic acid was used as the ligand.

### Support of Seed Crystals

A support that supported the seed crystals was obtained in the same manner as in Example 1-1, except that CAU-10-OCH₃ was used as the seed crystals.

### Formation of MOF Membrane

A starting material solution was prepared in the same manner as in Example 1-1, except that 5-methoxy isophthalic acid was used as the ligand, and sodium format was not added to the Al source solution. The molar ratio of aluminum sulfate 14-18 water, 5-methoxy isophthalic acid, ion-exchanged water, and DMF was set to 1:1:2352:193. The Al source solution before the start of mixing had a pH of 3.1, and the starting material solution after the end of the mixing had a pH of 2.9. The starting material solution was clear.

Then, the starting material solution and the support with the seed crystals deposited thereon were placed in a container made of Teflon (registered trademark) and was subjected to Solvothermal synthesis at 130° C. for 12 hours to obtain an MOF membrane complex in which a CAU-10-OCH₃ membrane was formed on the support. This MOF membrane complex was cleaned three times with ion-exchanged water and ethanol. Thereafter, the MOF membrane complex was dried at 80° C. for three hours in a dryer.

The average membrane thickness of the MOF membrane according to Example 5 was 2.5 μm. The in-hole evaluation value was 10%. The inter-hole evaluation value was 12%.

### Example 6: CAU-10-OH

### Preparation of Seed Crystals

Seed crystals of CAU-10-OH were obtained in the same manner as in Example 1-1, except that 0.24 g of 5-hydroxy isophthalic acid was used as the ligand.

### Support of Seed Crystals

A support that supported the seed crystals was obtained in the same manner as in Example 1-1, except that CAU-10-OH was used as the seed crystals.

### Formation of MOF Membrane

A starting material solution was prepared in the same manner as in Example 2-1, except that 5-hydroxy isophthalic acid was used as the ligand. The molar ratio of aluminum chloride hexahydrate, 5-hydroxy isophthalic acid, ion-exchanged water, and DMF was set to 1:1:2352:193. The Al source solution before the start of mixing had a pH of 3.2, and the starting material solution after the end of mixing had a pH of 3.0. The starting material solution was clear.

Then, the starting material solution and the support with the seed crystals deposited thereon were placed in a container made of Teflon (registered trademark) and was subjected to Solvothermal synthesis at 130° C. for 12 hours to obtain an MOF membrane complex in which a CAU-10-OH membrane was formed on the support. This MOF membrane complex was cleaned three times with ion-exchanged water and ethanol. Thereafter, the MOF membrane complex was dried at 80° C. for three hours in a dryer.

The average membrane thickness of the MOF membrane according to Example 6 was 2.3 μm. The in-hole evaluation value was 13%. The inter-hole evaluation value was 16%.

### Comparative Example 1: CAU-10—NH₂

In the preparation of the starting material solution for forming an MOF membrane, an MOF membrane complex was obtained in the same manner as in Example 2-1, except that the ligand solution was introduced and mixed all at once into the Al source solution. The Al source solution before the start of mixing had a pH of 2.8, and the starting material solution after the end of mixing had a pH of 2.6. The starting material solution was cloudy. The average membrane thickness of the MOF membrane according to Comparative Example 1 was 0.9 μm. The in-hole evaluation value was 40%. The inter-hole evaluation value was 31%.

### Comparative Example 2: CAU-10—NH₂

An MOF membrane complex was obtained in the same manner as in Example 2-1, except that the molar ratio of aluminum chloride hexahydrate, 5-amino isophthalic acid, ion-exchanged water, and DMF in the starting material solution for forming the MOF membrane was set to 1:1:134:8. The Al source solution before the start of mixing had a pH of 2.1, and the starting material solution after the end of mixing had a pH of 1.8. The starting material solution was cloudy. The average membrane thickness of the MOF membrane according to Comparative Example 2 was 4.6 μm. The in-hole evaluation value was 35%. The inter-hole evaluation value was 30%.

The above-described examples suppress variations in membrane thickness within the through holes 111 and achieve the in-hole evaluation value of less than or equal to 30%. The above examples also suppress variations in membrane thickness among the through holes 111 and achieve the inter-hole evaluation value of less than or equal to 30%.

As additional examples, as shown in Table 2, the degree of cloudiness in the starting material solution was checked by setting the molar ratio of the organic solvent to the ligand in the ligand solution for CAU-10—NH₂ synthesis to a value within the range between the values in Example 2-1 and Comparative Example 2 and smaller than 40. The other conditions were the same as those in Example 2-1 and Comparative Example 2. According to Additional Example 1 in which the molar ratio of the organic solvent to the ligand was 33, the Al source solution before the start of mixing had a pH of 2.7, and the starting material solution after the end of mixing had a pH of 2.4. In Additional Example 2 in which the above-described molar ratio was 24, the Al source solution before the start of mixing had a pH of 2.6, and the starting material solution after the end of mixing had a pH of 2.2. In Additional Example 3 in which the above-described molar ratio was 16, the Al source solution before the start of mixing had a pH of 2.4, and the starting material solution after the end of mixing had a pH of 2.0. In any of Additional Examples 1 to 3, the starting material solution was cloudy.

TABLE 2

| | | | | Molar | Cloud- |
|---|---|---|---|---|---|
| | | pH | | ratio of | iness of |
| | Type of | Before | After | Solvent | Starting |
| | CAU-10 | Mixing | Mixing | to Ligand | Material |
| Example 2-1 | CAU-10-NH₂ | 2.8 | 2.6 | 41 | No |
| Additional | CAU-10-NH₂ | 2.7 | 2.4 | 33 | Yes |
| Example 1 | | | | | |
| Additional | CAU-10-NH₂ | 2.6 | 2.2 | 24 | Yes |
| Example 2 | | | | | |
| Additional | CAU-10-NH₂ | 2.4 | 2.0 | 16 | Yes |
| Example 3 | | | | | |
| Comparative | CAU-10-NH₂ | 2.1 | 1.8 | 8 | Yes |
| Example 2 | | | | | |

As other additional examples, as shown in Table 3, the degree of cloudiness in the starting material solution was checked by setting the molar ratio of the organic solvent to the ligand in the ligand solution for CAU-10-CH₃ synthesis to a value within the range of around 40. The other conditions were the same as those in Example 3. In Additional Example 4 in which the molar ratio of the organic solvent to the ligand was 42, the Al source solution before the start of mixing had a pH of 2.8, and the starting material solution after the end of mixing had a pH of 2.5. In Additional Example 5 in which the above-described molar ratio was 33, the Al source solution before the start of mixing had a pH of 2.6, and the starting material solution after the end of mixing had a pH of 2.4. In Additional Example 4, the starting material solution was clear, but in Additional Example 5, the starting material solution was cloudy.

TABLE 3

| | | | | Molar | Cloudiness |
|---|---|---|---|---|---|
| | | pH | | Ratio of | of Starting |
| | Type of | Before | After | Solvent | Material |
| | CAU-10 | Mixing | Mixing | to Ligand | Solution |
| Example 3 | CAU-10-CH₃ | 3.1 | 2.9 | 123 | No |
| Additional | CAU-10-CH₃ | 2.8 | 2.5 | 42 | No |
| Example 4 | | | | | |
| Additional | CAU-10-CH₃ | 2.6 | 2.4 | 33 | Yes |
| Example 5 | | | | | |

As shown in Tables 2 and 3, if the molar ratio was set to 33 or less, the starting material solution was cloudy even if the rate at which the ligand solution is dropped was slowed down. From Examples 1-1, 1-2, 2-1 to 2-4, 3, 4, 5, and 6 and Comparative Example 2, it is clear that, in order to prevent the starting material solution from becoming cloudy, the molar ratio of the organic solvent to the ligand in the ligand solution is preferably higher than or equal to 40 and lower than or equal to 500. Moreover, it can be said from Examples 1-1, 1-2, 2-1 to 2-4, 3, 4, 5, and 6 and Comparative Example 1 that, while the starting material solution is generated by mixing the ligand solution into the Al source solution, the pH of the starting material solution during generation is preferably maintained to be higher than or equal to 2.5 and lower than or equal to 3.5.

The support 11 used in the above-described examples had a length of 16 cm in the direction along which the through holes 111 extend. In general, when the starting material solution becomes cloudy during Solvothermal synthesis, a depth exceeding 10 cm is considered to cause variations in thickness that affect quality. Therefore, the above-described method of producing the separation membrane complex 1 is suitable when the length of the through holes 111 is greater than or equal to 10 cm. In practice, the length of the through holes 111 in the separation membrane complex 1, i.e., the length of the separation membrane complex 1, is less than or equal to 200 cm.

In a cross section perpendicular to the direction of penetration through the support 11 used in the above-described examples, a maximum width of the through holes 111 was 2 mm. Thus, it can be said that an MOF membrane with little variations can be formed at least if this maximum width is greater than or equal to 1 mm. In practical application as the separation membrane complex 1, the maximum width of each through holes 111 is less than or equal to 20 mm. Since the support 11 used in the above-described examples had a length of 16 cm, it is demonstrated from the above-described examples that an MOF membrane with little variations can be formed if the length of the through holes 111 is 10 times or more and 100 times or less of the above-described maximum width of the through holes 111.

The separation membrane complex 1 and the method of producing the separation membrane complex 1 described above may be modified in various ways.

The separation membrane complex 1 may be produced by any method other than the above-described production method.

The separation apparatus 2 may separate any substance other than those described by way of example in the above description from the mixture of substances. The MOF membrane complex, which is the separation membrane complex 1, is not limited to a permeation type separation membrane, and may be an adsorption type separation membrane. The MOF membrane complex may also be used in any application other than the separation of fluid.

As already described, the support 11 is not limited to a so-called monolith type support. The number of through holes 111 may be one. If fluid permeation through the MOF membrane is not required, the support 11 is not limited to porous materials.

In the above-described embodiment, the support 11 is immersed in the starting material solution 51 in step S15 shown in FIG. 4. However, “being immersed” as used herein does not always mean the presence of the entire support 11 within the starting material solution 51, and includes a state in which only a part of the surface of the support 11 on which the MOF membrane is to be formed is in contact with the starting material solution 51. That is, the step of forming the MOF membrane corresponds to the step of applying the starting material solution 51 to the portion of the surface of the support 11 on which the MOF membrane is to be formed, and heating the starting material solution 51.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The MOF membrane complex according to the present invention is applicable in various fields related to, for example, the separation of a variety of substances.

### REFERENCE SIGNS LIST

1 separation membrane complex (MOF membrane complex)
11 support
12 separation membrane (MOF membrane)
51 starting material solution
111 through hole
S11 to S16 step

1. A method of producing an MOF membrane complex, comprising:
a) depositing a seed crystal of a CAU-10 MOF on a support;
b) preparing an Al source solution that is an aqueous solution containing an Al ion source;
c) preparing a ligand solution in which an organic ligand used for synthesis of the CAU-10 MOF dissolves in a solvent;
d) preparing a starting material solution by mixing said Al source solution and said ligand solution at a rate that does not cause the starting material solution to become cloudy; and
e) immersing said support in said starting material solution to form an MOF membrane that is the CAU-10 MOF on said support by Solvothermal synthesis.

2. The method of producing an MOF membrane complex according to claim 1, wherein
in said operation d), said ligand solution is added dropwise to said Al source solution while stirring.

3. The method of producing an MOF membrane complex according to claim 1, wherein
in said operation d), the starting material solution being produced has a pH that is maintained to be higher than or equal to 2.5 and lower than or equal to 3.5.

4. The method of producing an MOF membrane complex according to claim 1, wherein
a molar ratio of said solvent to said organic ligand in said ligand solution is higher than or equal to 40 and lower than or equal to 500.

5. The method of producing an MOF membrane complex according to claim 1, wherein
said organic ligand is any one selected from isophthalic acid, 5-amino isophthalic acid, 5-methyl isophthalic acid, 5-methoxy isophthalic acid, 5-nitro isophthalic acid, and 5-hydroxy isophthalic acid.

6. The method of producing an MOF membrane complex according to claim 1, wherein
said support has a through hole, and
in said operation e), said support is immersed in said starting material solution in a state in which a direction of extension of said through hole is parallel to a vertical direction.

7. An MOF membrane complex comprising:
a support having a through hole; and
an MOF membrane that is a CAU-10 MOF formed on an inner surface of said through hole or an outer surface of said support,
wherein, when said support is divided into three equal parts in a longitudinal direction along which said through hole extends, and a membrane thickness of said MOF membrane at a center of each of said three equal parts in said longitudinal direction is acquired to obtain three membrane thicknesses, a maximum value of differences between an in-hole average membrane thickness value, which is an average value of said three membrane thicknesses, and said three membrane thicknesses is less than or equal to 30% of said in-hole average membrane thickness value.

8. The MOF membrane complex according to claim 7, wherein
said support has two through holes that include said through hole and that are parallel to each other, and
a maximum value of differences between an inter-hole average membrane thickness value, which is an average value of in-hole average membrane thickness values of said two through holes, and said in-hole average membrane thickness values of said two through holes is less than or equal to 30% of said inter-hole average membrane thickness value.

9. The MOF membrane complex according to claim 7, wherein
said through hole has a length of greater than or equal to 10 cm and less than or equal to 200 cm.

10. The MOF membrane complex according to claim 7, wherein
said through hole has a maximum width of greater than or equal to 1 mm and less than or equal to 20 mm in a cross section perpendicular to said longitudinal direction, and
said through hole has a length that is 10 times or more and 100 times or less of said maximum width of said through hole.

11. An MOF membrane complex comprising:
a support; and
an MOF membrane that is a CAU-10 MOF formed on said support,
wherein an organic ligand used to form said MOF membrane is any one selected from 5-methyl isophthalic acid, 5-amino isophthalic acid, and 5-nitro isophthalic acid.
